(19) United States
(12) Patent Application Publication
(10) Pub. No.: US 2023/0270291 A1
(43) Pub. Date: Aug. 31, 2023

(54) Food Preparation Container Provided With A Handle For Easy Pouring And Scraping Of The Food Preparation

(71) Applicant: SEB S.A., Ecully (FR)

(72) Inventors: Jean-Louis Deshayes, La Chapelle-Au-Riboul (FR); Johan Nespoux, Le Horps (FR); Aurélie Besse, Brulon (FR)

(73) Assignee: SEB S.A., Ecully (FR)

(21) Appl. No.: 18/007,949

(22) PCT Filed: Jun. 4, 2021
(86) PCT No.: PCT/EP2021/065064

§ 371 Date: Dec. 2, 2022

(30) Foreign Application Priority Data
Jun. 5, 2020 (FR) FR2005920

(51) Int. Cl. A47J 45/06; A47J 43/07

(52) U.S. Cl. CPC A47J 45/062; A47J 43/0727

(57) ABSTRACT

A food preparation container includes a receptacle provided with a main opening for the introduction of food into the receptacle and the removal of the resulting food preparation from the receptacle. The food preparation container includes at least a first handle designed so that the receptacle can be handled while keeping it in a normal position with the main opening positioned at the top of the receptacle. The food preparation container includes a second handle comprising a body which has an underside with a cavity extending deep into the body, the cavity designed to accommodate at least the distal phalanges of at least the three middle fingers of a hand and to allow the receptacle to be held suspended by the distal phalanges in an inclined position for pouring or scraping the food preparation. A food preparation appliance includes the food preparation container.

### TECHNICAL FIELD

The present invention relates to a food preparation container for holding food for cooking. The invention also relates to a food preparation appliance that comprises such a food preparation container.

The main purpose of the invention is to make it easier to handle the food preparation container when using it, especially when pouring or scraping the food preparation made from the food and contained in said food preparation container.

### STATE OF THE ART

Food preparation appliances are well known to the person skilled in the art. Such a food preparation appliance may comprise a base that receives a food preparation container for holding food for cooking. The food preparation appliance may also comprise one or more work tools, such as a mixer or blender, stirring paddle, chopping knives, beater, kneader or crusher.

The work tool is placed in the food preparation container and coupled with a rotary drive assembly, which in turn is coupled with a rotary drive system on the base. The base and the food preparation container may also be designed for preparing hot food, for example soups, purées or stews, whereby a heating device arranged on the base and/or on the food preparation container then makes it possible to heat said food preparation container to warm or cook the food contained therein.

The food preparation container comprises a receptacle that has a top edge defining a main opening through which food is introduced into the receptacle. The receptacle may also comprise a spout arranged on its upper edge. This food preparation container is generally provided with one or with two handholds arranged on an upper rim of the receptacle, in order to handle said receptacle while keeping it in a normal position according to which the main opening remains at the top of the receptacle, thus preventing the food or the food preparation from spilling. When the food preparation is ready to be served, the cook may, for example, use a spoon or ladle to scoop out the food preparation and pour it into a serving dish or food preparation container; the cook may also occasionally pour the food preparation into a serving dish or food preparation container by tipping the receptacle. When pouring out the last of the food preparation into the serving dish or receptacle, or when said food preparation is pasty and sticks to the inner wall of the receptacle, the cook usually uses a spatula to scrape the inner wall and pour out the remaining food preparation. The cook therefore holds the handhold or one of the two handholds with one hand and manipulates the spatula with the other hand. Handling the food preparation container with one hand can prove difficult under these circumstances, especially when the food preparation container is heavy, as the cook's posture during this scraping phase is uncomfortable and the handle is not easy to grip. As a result, the cook may touch the outer wall of the receptacle with his or her hand and be burned, when this outer wall is hot.

There is a known Chinese utility model published under number CN204158184U, which discloses a food preparation container that comprises a receptacle comprising a top edge provided with a main opening, said food preparation container comprising two first flat handles positioned opposite each other around the receptacle and allowing said receptacle to be handled in a normal position in which the main opening remains at the top. In addition, the food preparation container comprises a second handle consisting of a shank attached to the upper rim of the receptacle at a downward slope, the shank being designed to be fully grasped and to hold the receptacle in a position that makes it easier to pour out the food preparation. This embodiment partially solves the aforementioned drawbacks, but is nevertheless still unsatisfactory as the cook's posture is not optimal in every case, for example when scraping the receptacle with a spatula.

### PRESENTATION OF THE INVENTION

The present invention aims to remedy the aforementioned drawbacks. To this end, the invention relates to a food preparation container that comprises a receptacle provided with an upper edge defining a main opening for the introduction of food into the receptacle and the removal from said receptacle of the food preparation made from the food. The food preparation container also comprises at least a first handhold mounted on an upper rim of the receptacle and designed so that the receptacle can be handled while keeping it in a normal position with the main opening positioned at the top of the receptacle. This normal position makes it possible to move the food preparation container from one place to another with no risk of spilling the food or the food preparation placed in the receptacle through the main opening, said main opening being more or less in a horizontal plane in this normal position.

More particularly, the underside has a cavity extending deep into said body forming a recess with a peripheral wall.

Thus the invention relates to a food preparation container comprising a receptacle provided with an upper edge defining a main opening for the introduction of food into the receptacle and the removal, from said receptacle, of the food preparation made from the food, the food preparation container comprising at least a first handhold mounted on an upper rim of the receptacle and designed so that the receptacle can be handled while keeping it in a normal position with the main opening positioned at the top of the receptacle, said food preparation container comprising a second handhold mounted on the upper rim of the receptacle and comprising a body with an underside, due to the underside having a cavity extending deep into said body forming a recess with a peripheral wall, said cavity being designed to accommodate therein at least the distal phalanges, preferably the distal and middle phalanges, of at least the three middle fingers of a hand and to allow said receptacle to be held suspended by means of said distal phalanges, in an inclined position for pouring or scraping the food preparation.

Most notably, according to the invention, the food preparation container comprises a second handhold mounted on the upper rim of the receptacle. This second handhold comprises a body with an underside that has a cavity extending deep into said body, said cavity being designed to accommodate therein at least the distal phalanges, preferably the distal and middle phalanges, of at least the three middle fingers of a hand and to allow said receptacle to be held suspended by means of said distal and potentially middle phalanges, in an inclined position for pouring or scraping the food preparation. In other words, the cavity on the underside of the body is sufficiently deep to form a space in the body to accommodate at least the distal phalanges of at least the three middle fingers of a hand, namely the index, middle and ring fingers, preferably the distal and middle phalanges of these three fingers, said space being accessible from the underside of the body. “At least the three middle fingers” means that the cavity may possibly also accommodate the distal phalanx and potentially the middle phalanx of the little finger of the hand, in addition to the index finger, middle finger and ring finger, either because said cavity has been designed for this purpose or because the total width of said fingers of the hand allows it.

Thus, the cook can grasp the second handhold by inserting, into the cavity, the distal phalanges and, preferably, also the middle phalanges of the three middle fingers of his or her hand, and even the little finger, and by placing his or her palm around the outer rim of the body of this second handhold, then said cook lifts the food preparation container by means of said phalanges placed in the cavity, the suspended receptacle then naturally assuming an inclined position in equilibrium according to which the main opening is tilted downwards on the side opposite to the second handhold and remains in equilibrium in an inclined plane positioned between the horizontal and the vertical. According to this design, the cook can lift the receptacle with one hand and turn the main opening of the receptacle facing him or her or slightly to the side, in said inclined position, without having to exert an effort with the wrist of this hand, which allows him or her to view the inside of the receptacle and, using a spatula, to scrape around its inner walls and its bottom with the other hand. Moreover, the receptacle can be handled with no risk of touching its external wall, since the distal and potentially middle phalanges of the three middle fingers of the hand, and even of the index finger, are placed in the cavity and the rest of the hand is away from this external wall, which prevents the risk of burns when the external wall is hot.

According to one embodiment of the food preparation container disclosed in the invention, the latter comprises two first handholds positioned opposite each other on the upper rim of the receptacle. Thus, the cook can hold the receptacle with both hands while keeping its main opening in the normal position, which makes it easier to carry the food preparation container in said normal position when the receptacle is filled with food or with the food preparation, in particular for receptacles with a large volume, for example a volume of from two to five liters. Of course, the invention can be used for food preparation containers comprising a single first handhold, for example a saucepan or a blender bowl.

Preferably, according to this aforementioned embodiment of the food preparation container, the second handhold is positioned between sixty degrees (60°) and one hundred twenty degrees (120°), preferably ninety degrees (90°), relative to the two first handholds, around the upper rim of the receptacle.

According to a first embodiment of the food preparation container, when the latter comprises two first handholds, said two first handholds are connected to each other by a semicircular rim piece that follows the upper rim of the receptacle, the second handhold being arranged on the rim piece.

According to a second embodiment of the food preparation container, regardless of whether the container comprises one or more first handholds, the second handhold is separate from the at least one first handhold. Preferably, according to this embodiment of the food preparation container, the body of the second handhold comprises an upper piece and a lower piece attached to each other and attached to the upper rim of the receptacle by means of a assembly system, the lower piece comprising the cavity.

According to the food preparation container disclosed in the invention, the part of the upper rim of the receptacle positioned opposite the second handhold does not have the at least one first handhold. This prevents the food preparation from spilling onto the first handhold when the cook handles the receptacle by holding it by the second handhold and pours or scrapes off the food preparation. Preferably, the upper edge of the receptacle comprises a spout positioned opposite the second handhold, to make it easier to pour out the food preparation.

According to a preferential embodiment of the food preparation container disclosed in the invention, the cavity on the body of the second handhold is designed to suspend the receptacle at an inclination comprised between sixty degrees (60°) and eighty degrees (80°) relative to the vertical, preferably seventy degrees (70°) relative to the vertical. This provides adequate viewing and access to the interior of the receptacle in its inclined position.

According to one embodiment of the food preparation container disclosed in the invention, the latter comprises a closing lid capable of closing the main opening of the receptacle. In addition, a locking system is positioned between the lid and the at least one first handhold to move the lid to a locked position in which said lid closes the main opening of the receptacle and remains locked in that closed position, and an unlocked position in which the lid can be removed from the receptacle to access the main opening. This makes it possible to securely close the food preparation container, for example while cooking the food placed in the receptacle, or even while processing the food placed in the receptacle with a rotary work tool. Preferably, according to this embodiment, the food preparation container comprises a system for identifying the locked and unlocked position of the lid, the identification system being arranged between the lid and the second handhold. This makes it possible to visually check that the receptacle is correctly closed by the lid.

According to one embodiment of the food preparation container disclosed by the invention, the receptacle comprises a bottom comprising a central opening suitable for receiving a rotary drive assembly, said rotary drive assembly being suitable for rotating a rotary work tool, which may or may not be removable from the rotary drive assembly, said rotary work tool being placed in said receptacle. This rotary work tool may be, for example, a mixer or blender, a stirring blade, chopping knives, a beater, a kneader or a crusher. Such a food preparation container will be used in a food preparation appliance which also has a base for receiving said food preparation container.

According to one embodiment of the food preparation container disclosed in the invention, the receptacle is designed in a metallic material, coated if desired, preferably made of stainless-steel or of coated aluminum alloy, for example PTFE. In addition, the at least one first handhold and the second handhold are made of a thermo-insulating material, preferably Bakelite®, PBT or glass-filled PP. Such a food preparation container is designed to be heated by means of a heating device in order to cook food placed in the receptacle.

The food preparation container according to the invention may be designed to be placed in an oven or on a cooktop, in order to cook food placed in the receptacle to make the food preparation. However, the food preparation container will preferably be used on a standalone food preparation appliance to make hot food preparations or even to make cold food preparations. To this end, the invention also relates to a food preparation appliance, which comprises a food preparation container having either or both of the above features and a base designed to receive the food preparation container.

According to one embodiment of the food preparation appliance, the food preparation container comprises a receptacle made of a heat-conducting material and comprising a central opening in the bottom. The at least one first handhold and the second handhold of the food preparation container are made of a thermo-insulating material. In addition, the food preparation appliance comprises at least one rotary work tool suitable to be placed in the receptacle by inserting it through the main opening thereof and a rotary drive assembly suitable to be tightly mounted on the central opening of the bottom of the receptacle to drive the rotary work tool placed in said receptacle. Furthermore, the food preparation appliance comprises a device for heating the bottom of the receptacle and a device for driving the rotary drive assembly mounted on said bottom, when the food preparation container is mounted on said base. The rotary work tool may be, for example, a mixer or blender, a stirring blade, chopping knives, a beater, a kneader or a crusher.

According to a first embodiment, the food preparation container may comprise the heating device, which will be arranged in the bottom of the food preparation container, under the bottom of the receptacle. According to a second embodiment, the base may comprise the heating device that heats the receptacle when the food preparation container is positioned on the base. This heating device may comprise an electrical heating element such as a resistance or an induction heating device.

### BRIEF DESCRIPTION OF THE FIGURES

The features and advantages of the invention will become apparent from the following description based on figures, among which:

FIG. 1 illustrates an overview of a non-limiting embodiment of a food preparation appliance;

FIG. 2 illustrates an overview of a food preparation container intended for use on the food preparation appliance in FIG. 1, said food preparation container being in a normal position;

FIG. 3 illustrates in part the food preparation container in FIG. 2, in which the second handhold appears in an exploded view;

FIG. 4 illustrates according to a first viewing angle an upper piece of the body of the second handhold;

FIG. 5 illustrates said top piece in FIG. 4 from a second viewing angle;

FIG. 6 illustrates a first viewing angle of a lower piece of the body of the second handhold;

FIG. 7 illustrates from a second viewing angle of said lower piece in FIG. 6;

FIG. 8 illustrates a cross-section of the food preparation container in FIG. 2, placed in an equilibrium in an inclined position according to which it is held in suspension by the second handhold.

### DETAILED DESCRIPTION OF THE INVENTION

In the remainder of the description, the terms “upper,” “lower,” “top,” “bottom,” “front,” “back,” “side,” “vertical,” “horizontal,” that may be used in this description will be used in consideration of the normal position of the elements of the food preparation appliance placed in a functional configuration, facing the user on a table or countertop.

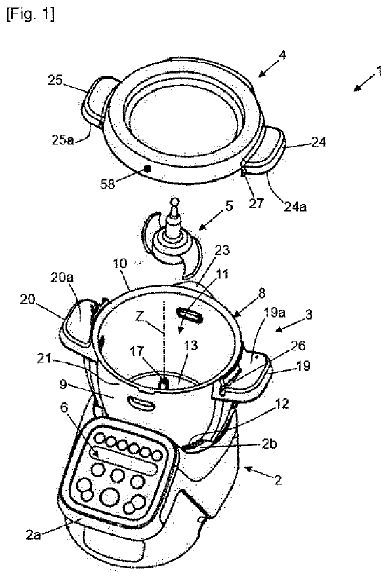

FIG. 1 illustrates an exemplary embodiment of a food preparation appliance 1 comprising a base 2, a food preparation container 3, a lid 4, and a rotary work tool 5. The front panel 2a of the base 2 comprises a keyboard 6 that enables the user to select the type of food preparation to be carried out, for example preparing a sauce, a soup, a pastry, a mousse dessert, whipped cream or vegetable purée, steam cooking or immersion cooking, as well as switching on the rotary work tool 5, switching the food preparation container 3 to a warming mode and switching on a timer. Of course, these various operating programs are not limiting on the food preparation appliance 1 disclosed in the invention. These various programs will be started and controlled by a control circuit (not shown) built into the base 2.

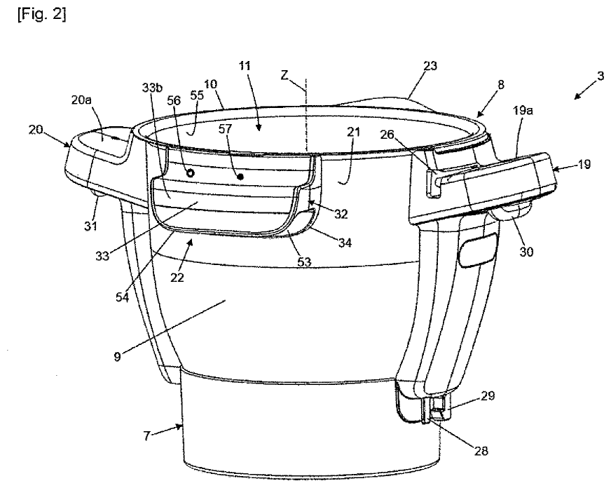

With reference to FIGS. 1 and 2, the food preparation container 3 comprises a baseplate 7 arranged at a lower end of a receptacle 8, said receptacle 8 being suitable for receiving foods for making a food preparation. The receptacle 8 comprises a rim 9 which is delimited by an upper edge 10 defining a main opening 11 through which the food is introduced into the receptacle 8 and the resulting food preparation is poured out. The baseplate 7 fits into a housing 12 on the upper side 2b of the base 2, making it possible to latch the food preparation container 3 onto the base 2. The receptacle 8 comprises a bottom 13 which is provided with a central opening 14, as illustrated in FIG. 8, this central opening 14 being accessible through the main opening 11 of the receptacle 8, on one hand, and through the underside 15 of the baseplate 7 which comprises a central recess 16 opening onto said bottom 13, on the other hand. This central opening 14 enables a rotary drive assembly 17 to be mounted on the bottom 13 of the receptacle 8, the rotary drive assembly 17 having a bayonet fastening system (not illustrated) for achieving said mounting and a gasket (not illustrated) for achieving a seal on the bottom 13 of the receptacle 8 at the level of this central opening 14. This rotary drive assembly 17 is used to rotate the rotary work tool 5 along a Z axis, as shown in FIG. 1. The rotary drive assembly 17 is itself rotated along the Z axis by means of a motorized device (not illustrated) housed in the base 2, the motorized device comprising, for example, an electric motor whose drive shaft is coupled to said rotary drive assembly 9 by means of a coupling system, for example of the spline type, said coupling system being positioned when the baseplate 7 of the food preparation container 3 is engaged in the housing 12 on the base 2.

The food preparation container 3 can be configured to hold hot food or even to warm food in the receptacle 8. For this purpose the receptacle 8 can be made of a metallic material, coated if desired, preferably made of stainless-steel, or of coated aluminum alloy, for example PTFE.

According to one embodiment, the food preparation container 3 comprises a resistance heating element 18 which is arranged under the bottom 13 of the receptacle 8. In particular, the resistance heating element 18 can be arranged inside a sole positioned under the bottom 13 or under a sole positioned under the bottom 13. Said sole is preferably made of aluminum to ensure good thermal conduction. The resistance heating element 18 is electrically controlled by means of a control circuit (not illustrated) arranged in the base 2 and a connection system, such as electric pins arranged in the baseplate 7 and coming into mechanical contact with electric strips arranged on the base 2, when the baseplate 7 is fitted into the housing 12 on the base 2. The control circuit also manages the control of the motorized device that rotates the rotary work tool 5, the various food preparation programs and the timer, among other things.

This use of a device for heating the receptacle on the food preparation appliance 1 is not limitative; one might, for example, foresee the resistance heating element 18 on the base 2 and coming into contact with or near the bottom 13 of the receptacle 8 when the baseplate 7 is fitted into the housing 15, the baseplate 7 being in this case designed for this purpose. Alternatively, an induction heating device could be foreseen instead of a resistance heating element 18, the induction heating device being preferably arranged in the base 2 to heat the bottom 13 of the receptacle 8 and/or the lower part of the receptacle 8. The food preparation container 3 can then be made without a baseplate under the receptacle 8.

Referring to FIGS. 1 and 2, the food preparation container 3 comprises two first handholds 19, 20 which are oppositely attached to an upper part 21 of the rim 9 of the receptacle 8, these two first handholds 19, 20 extending radially in relation to the rim 9 which is preferably cylindrical. These two first handholds 19, 20 make it possible to handle the food preparation container 3 with both hands while keeping the main opening 11 of the receptacle 8 in a normal, more or less horizontal position, preventing the food or the food preparation made from the food from spilling out of the receptacle 8. The food preparation container 3 also comprises a second handhold 22 which is preferably positioned at 90° to the two first handholds 19, 20, said second handhold 22 being positioned opposite a spout 23 arranged on the upper edge 10 of the receptacle 8. This second handhold 22 only appears in FIG. 2, but it will also be used on the food preparation container 3 in FIG. 1.

The lid 4 also comprises two oppositely-positioned, radially-extending third handholds 24, 25, said third handholds 24, 25 being similar in shape to the first handholds 19, 20, as illustrated in FIG. 1. The first handholds 19, 20 each comprise on their upper side 19a, 20a a notch 26 which extends circularly adjacent to the upper part 21 of the rim 9 of the receptacle 8, with only the notch 26 on the first handhold 19 appearing in FIGS. 1 and 2. The third handholds 24, 25 of the lid 4 each comprise a tab 27 on their underside 24a, 25a, with only the tab 27 on the third handhold 24 appearing in FIGS. 1 and 2. The lid 4 for closing the main opening 11 of the container 3 is put on by positioning the lid 4 with the third handholds 24, 25 offset relative to the first handholds 19, 20, corresponding to an unlocked position, then by rotating the lid 4 along the Z axis so as to engage the tabs 27 on these third handholds 24, 25 inside the respective notches 26 on the first handholds 19, 20, until they reach the stop, which corresponds to a locking position of the lid 4 on the receptacle 8. Positioning the lid 4 in the locking position of the receptacle 8 makes it possible to actuate a mechanical stop 28 extending downwards on the outside of the rim 9 of the receptacle 8, said mechanical stop 28 actuating a position sensor (not illustrated) arranged on the base 2, when the sole 7 is engaged in the housing 12 of said base 2.

The food preparation container 3 also comprises two anchoring tabs 29 that extend downward below the first handholds 19, 20, with only the anchoring tab 29 on the side of the first handhold 19 appearing in FIG. 2. These anchoring tabs 29 cooperate with complementary anchoring tabs (not illustrated) arranged on the base 2, for locking the food preparation container 3 when the baseplate 7 is engaged in the housing 12. The anchoring tabs 29 are actuated by means of two respective triggers 30, 31 arranged under the first handholds 19, 20, in order to allow their disengagement from the complementary anchoring tabs and to unlock the sole 7 from the housing 12, in order to extract the food preparation container 3 from the base 2.

The features described above, except for those relating to the second handhold 22, can already be found on a food preparation appliance marketed by the applicant under the name COMPANION®. The person skilled in the art will therefore be able to refer to it for a preferential embodiment of the food preparation appliance 1 disclosed in the invention incorporating, in addition, the features relating to the second handhold 22.

The following description relates specifically to a preferential implementation of the second handhold 22 on the food preparation appliance 1 in FIG. 1. As previously stated and illustrated in FIG. 2, the second handhold 22 is positioned at ninety degrees (90°)—rotation about the Z axis—from the two first handholds 19, 20 and opposite the spout 23. Variants of the food preparation appliance 1 could be considered by placing the second handhold 22 between sixty degrees (60°) and ninety degrees (90°) relative to one of the first handholds 19 and, conversely, between one hundred and twenty degrees (120°) and ninety degrees (90°) relative to the other of the first handholds 20. In other variants of the food preparation appliance 1 equipped with a single first handhold, the second handhold 22 may also be between zero degrees (0°) and ninety degrees (90°) relative to the first handhold and facing the spout 23.

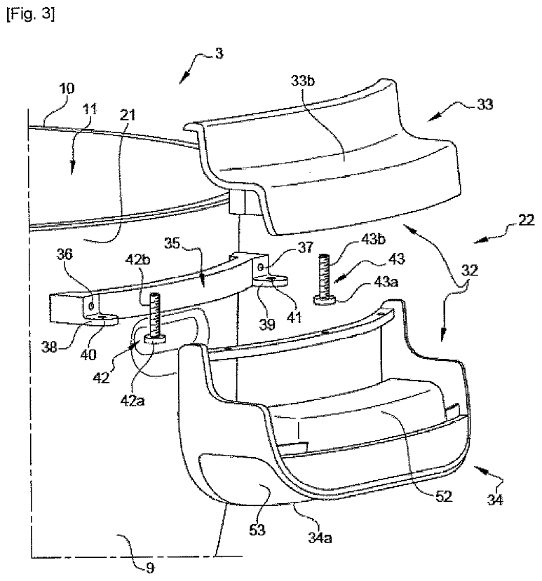

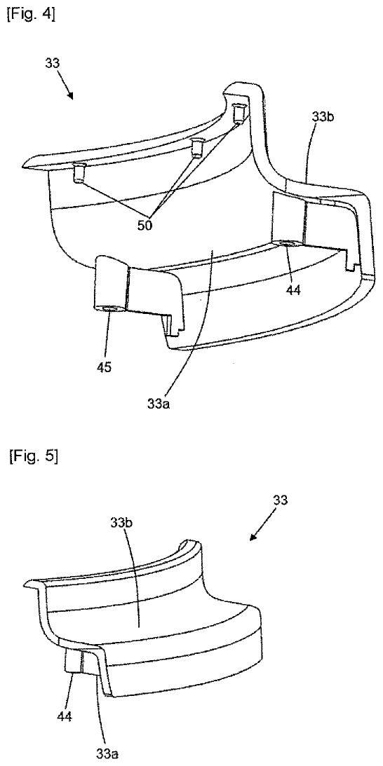

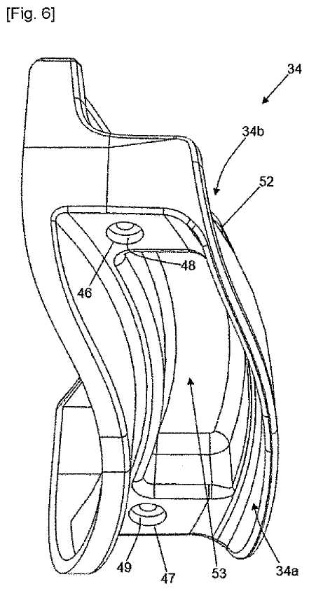

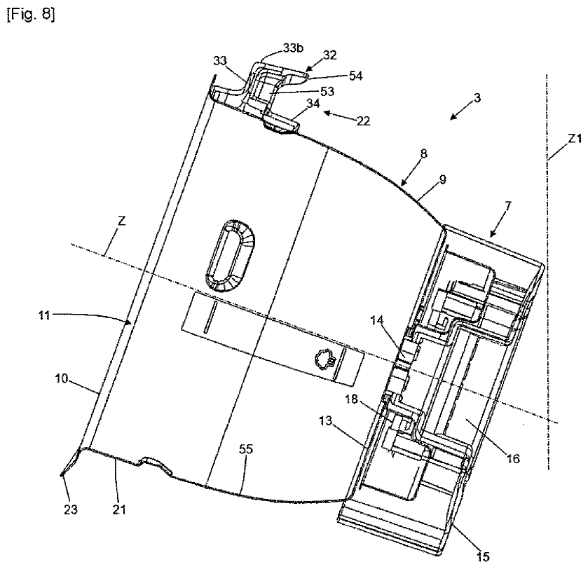

In the embodiment illustrated in FIGS. 2 through 8, the second handhold 22 consists of a body 32 formed of an upper part 33, a lower part 34 and a bridge piece 35. The bridge piece 35 is screwed onto the upper part 21 of the rim 9 of the receptacle 8 by means of two fastening screws (not illustrated) running through said rim 9 and tightening into two threaded holes 36, 37 of the bridge piece 35. The bridge piece 35 comprises two support lugs 38, 39, each of which is provided with a through orifice 40, 41 through which run two fastening screws 42, 43. The upper part 33 comprises on its underside 33a two threaded holes 44, 45 into which the two fastening screws 42, 43 are screwed. The lower part 34 comprises two through holes 46, 47 which comprise, on the side of the underside 34a of said lower part 34, a counterbore 48, 49 for receiving the heads 42a, 43a of the fastening screws 42, 43. The center distance is the same between the two through orifices 40, 41, between the two threaded holes 44, 45 and between the two through holes 46, 47. The bodies 42b, 43b of the fastening screws 42, 43 run through the through holes, 46, 47, then the through orifices 40, 41 and are screwed into the threaded holes 44, 45, the bridge piece 35 thus ensuring the fastening of the upper part 33 and the lower part 34 between which it is sandwiched, with the upper part 21 of the rim 9 of the receptacle 8. When the upper part 33 and the lower part 34 are assembled together, the three studs 50 on the underside 33a of the upper part 33 fit into the three orifices 51 on the upper side 34b of the lower part 34, thus ensuring a precise and stable assembly between the upper part 33 and the lower part 34 forming the body 32.

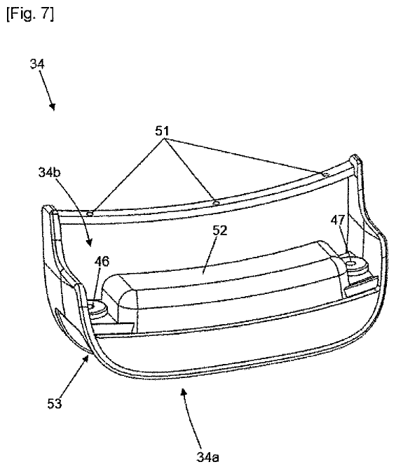

The upper part 33 comprises an upper side 33b with a stepped shape as illustrated in particular in FIGS. 2 through 5. In addition, the lower part 34 has a pronounced deformation 52 extending toward the upper part 33 so as to provide a cavity 53 on the underside 34a of said lower part 34 that extends upward deep into the body 32 of the second handhold 22, as illustrated in FIGS. 6 through 8. As can be clearly seen in FIG. 6, this cavity 53 extends deep into the body 32, forming a recess with a peripheral wall. This cavity 53 accommodates the distal phalanges and preferably also the middle phalanges of the three middle fingers (index, middle and ring fingers) of a hand. It could also be foreseen that the distal phalanx and preferably also the middle phalanx of the little finger (ring finger) of the hand can also fit into this cavity 53. The stepped shape of the upper side 33b of the upper part 33 allows the palm of the hand and the thumb to be suitably positioned on it when the distal and medial phalanges of the fingers (index finger, middle finger, ring finger and potentially little finger) of the hand are placed in the cavity 53, while the proximal phalanges of said fingers are placed on the lower edge 54 of the body 32. Thus, the body 32 of the second handhold 22 is suitably gripped, with no risk of the hand coming into contact with the rim 9 of the receptacle 8; as the second handhold 22 is made of a thermo-insulating material, the cook's hand cannot be burned. This thermo-insulating material can be chosen among Bakelite®, PBT (Polybutylene Terephthalate), PP (Polypropylene) with fiberglass filling. The first handholds 19, 20 of the food preparation container 3 and the third handholds 24, 25 of the lid 4 are also made of this thermo-insulating material.

According to this design, the cook can lift the food preparation container 3 with one hand by placing his or her distal and middle phalanges into the cavity 53, as described above. Offsetting the second handhold 22 relative to the center of gravity of the food preparation container 3 and holding said food preparation container 3 up solely by means of the distal and middle phalanges placed in the cavity 53 allow the container 8 to be naturally tilted forward by gravity (on the side of the pouring spout 23) until it reaches a tilted position in equilibrium as illustrated in FIG. 8. Preferably, in this tilted position, the inclination of the Z-axis of the food preparation container 3 relative to a vertical axis Z1 will be comprised between sixty degrees (60°) and eighty degrees (80°), preferably seventy degrees (70°). Of course, the shape of this cavity 53 extending deep into the body 32 of the second handhold 22 and the position of the latter relative to the center of gravity of the food preparation container 3 can be varied in order to change the inclination of the axis Z of the food preparation container 3 relative to the vertical axis Z1, in the inclined equilibrium position.

Once the cooking process is complete, the cook can remove the food preparation container 3 from the base 2 by lifting it with both hands using the first handholds 19, 20 and activating the triggers 30, 31, thus keeping the main opening 11 of the receptacle 8 in its normal, substantially vertical position while the food preparation container 3 is being moved. The cook will have previously unlocked and removed the lid 4 from the receptacle 8; however, he or she can also do so after removing the food preparation container 3 from the base 2, once said food preparation container 3 is placed on a surface such as a table or countertop. Depending on whether the consistency of the food preparation is liquid or pasty, the cook can then start pouring the food preparation either by first tilting the receptacle 8 on the side of the pouring spout 23 while handling the two first handholds 19, 20, or by directly tilting said receptacle 8 by holding it up by the second handhold 22 with one hand, as previously stated, the receptacle then naturally assuming an inclined position in equilibrium, which allows the cook to use the other hand to manipulate a spatula in order to scrape the inner wall 55 and the bottom 13 of the receptacle 8. Advantageously, the cook can place the main opening 11 of the receptacle 8 facing him or her while holding it up in a tilted position with one hand, which allows him or her to adequately view the food preparation in the receptacle 8 while scraping, without having to exert effort with his or her wrist to rotate said central opening 11 into a suitable viewing position.

Other characteristics are possible within the context of the invention. For example, the upper side 33b of the upper part 33 of the body 32 may comprise two marks 56, 57, and the lid 4 may comprise a mark 58 that matches either of the two marks 56, 57 on the second handhold 22, to indicate the locking and unlocking position of the lid 4 on the food preparation container 3.

Variants are also possible within the scope of the invention. For example, it can be foreseen that the two first handholds 19, 20 and the second handhold 22 are made in one block. For example, the two first handholds 19, 20 may be connected to each other by a semicircular rim piece (not illustrated) that follows the upper part 21 of the rim 9 of the receptacle 8, the second handhold 22 being arranged on the rim piece, preferably in the middle part of said rim piece in order to position the second handhold 22 at ninety degrees (90°) relative to the two first handholds 19, 20.

The body 32 of the second handhold 22 could also be designed as a single piece (not illustrated) on the underside of which the cavity 53 would be arranged in order to accommodate the distal phalanges and, preferably, also the middle phalanges of the index, middle and ring fingers of a hand, and preferably also the middle phalanges of the index finger, middle finger and ring finger of a hand, and even of the little finger, so that when the food preparation container 3 is held up, said food preparation container 3 balances at an angle of inclination in which the Z axis preferably forms an angle of seventy degrees (70°) with respect to the vertical axis Z1.

The position of the second handhold 22 can also vary in relation to the previous description, namely in relation to the first two handholds 19, 20, the important thing being that this second handhold 22 is not positioned opposite a first handhold in order to prevent the food preparation from spilling onto said first handhold while pouring or scraping the food preparation.

In the foregoing description of an embodiment, the food preparation container 3 constitutes a component of the food preparation appliance 1. Of course, the invention could be applied to other food preparation containers that can be used separately from a base 2, for example a pressure cooker, a pot or a stewpot. The invention could also be used with a food preparation container 3 used in a food preparation appliance 1 comprising a drive outlet arranged above the food preparation container 3 or extending into the food preparation container 3 and designed to receive a rotary work tool 5 extending into the food preparation container 3.

1. A food preparation container comprising:
a receptacle provided with an upper edge defining a main opening for the introduction of food into the receptacle and the removal, from said receptacle, of prepared food;
at least one first handhold mounted on an upper rim of the receptacle and configured so that the receptacle can be handled while keeping the receptacle in a position with the main opening positioned at a top of the receptacle;
a second handhold mounted on the upper rim of the receptacle and comprising a body with an underside,
wherein a part of the upper rim of the receptacle positioned opposite the second handhold does not have the at least one first handhold, and
wherein the underside has a cavity extending into said body to form a recess with a peripheral wall, said cavity configured to accommodate therein at least distal phalanges of at least three middle fingers of a hand and to allow said receptacle to be held in suspension by said distal phalanges, in an inclined position for pouring or scraping the prepared food.

2. The food preparation container according to claim 1, wherein the at least one first handhold includes two first handholds positioned opposite each other on the upper rim of the receptacle.

3. The food preparation container according to claim 2, wherein the second handhold is positioned between sixty degrees (60°) and one hundred and twenty degrees (120°) relative to the two first handholds, around the upper rim of the receptacle.

4. The food preparation container according to claim 2, wherein the two first handholds are connected to each other by a semicircular rim piece following the upper rim of the receptacle, and wherein the second handhold is configured on the rim piece.

5. The food preparation container according to claim 1, wherein the second handhold is separate from the at least one first handhold.

6. The food preparation container according to claim 5, wherein the body of the second handhold comprises an upper part and a lower part fastened to each other and fastened to the upper rim of the receptacle by an assembly system, the lower part comprising the cavity.

7. The food preparation container according to claim 1, wherein the upper edge of the receptacle comprises a spout positioned opposite the second handhold.

8. The food preparation container according to claim 1, wherein the cavity on the body of the second handhold is configured to hold the receptacle up at an inclination of between sixty degrees (60°) and eighty degrees (80°) from vertical.

9. The food preparation container according to claim 1, further comprising a closing lid adapted to close the main opening of the receptacle with a locking system disposed between the lid and the at least one first handhold to bring the lid into a locked position in which said lid closes the main opening of the receptacle and remains locked in the closed position and an unlocked position in which the lid is configured to be removed from the receptacle in order to access the main opening.

10. The food preparation container according to claim 9, further comprising a system for marking the locked and unlocked positions of the lid between said lid and the second handhold.

11. The food preparation container according to claim 1, wherein the receptacle comprises a bottom comprising a central opening capable of receiving a rotary drive assembly adapted to rotate a rotary work tool.

12. The food preparation container according to claim 1, wherein the receptacle is made of a metallic material, with the at least one first handhold and the second handhold being made of a thermo-insulating material.

13. A food preparation appliance comprising the food preparation container of claim 1 and a base configured to receive the food preparation container.

14. The food preparation appliance according to claim 13, further comprising at least one rotary work tool adapted for placement in the receptacle by introducing the at least one rotary work tool through the main opening of the receptacle, and a rotary drive assembly adapted to be mounted on a central opening of the bottom of the receptacle for driving the at least one rotary work tool placed in said receptacle, the food preparation appliance further comprising a device for heating the bottom of the receptacle and a device for rotating the rotary drive assembly mounted on said bottom, when the food preparation container is mounted on said base.

15. The food preparation container according to claim 2, wherein the second handhold is positioned at ninety degrees (90°) relative to the two first handholds, around the upper rim of the receptacle.

16. The food preparation container according to claim 1, wherein the cavity on the body of the second handhold is configured to hold the receptacle up at an inclination of seventy degrees (70°) from vertical.

17. The food preparation container according to claim 11, wherein the rotary work tool is configured to be removable with respect to said rotary drive assembly placed in said receptacle.

18. The food preparation container according to claim 12, wherein the receptacle is made of stainless steel.

19. The food preparation container according to claim 12, wherein the receptacle is made of coated aluminum.

20. The food preparation container according to claim 12, wherein the receptacle is made of PTFE coated aluminum.
